(19) United States
(12) Patent Application Publication
(10) Pub. No.: US 2015/0227825 A1
(43) Pub. Date: Aug. 13, 2015

(54) IMAGE ADJUSTING APPARATUS, IMAGE FORMING APPARATUS, AND MANAGING APPARATUS

(71) Applicant: FUJI XEROX CO., LTD., Tokyo (JP)

(72) Inventors: Toshio KORIYAMA, Kanagawa (JP); Shinji TABATA, Kanagawa (JP); Shinsuke SUGI, Kanagawa (JP); Jun KOYATSU, Kanagawa (JP); Kenji MORI, Kanagawa (JP)

(21) Appl. No.: 14/458,697

(22) Filed: Aug. 13, 2014

(30) Foreign Application Priority Data
Feb. 13, 2014 (JP) 2014-025346

(51) Int. Cl. G06K 15/02

(52) U.S. Cl. CPC G06K 15/1872

(57) ABSTRACT

Provided is an image adjusting apparatus, including an acceptable adjustment factor acquisition unit that acquires acceptable adjustment factors which are factors for adjusting an image forming unit and adjustment factors accepted to a user who performs an image adjustment, an examination result acquisition unit that acquires an examination result of an image formed by the image forming unit, and a real adjustment factor selection unit that selects real adjustment factors which are factors for actually performing an image adjustment with respect to the image forming unit among the acceptable adjustment factors based on the acquired examination result.

### CROSS-REFERENCE TO RELATED APPLICATIONS

This application is based on and claims priority under 35 USC 119 from Japanese Patent Application No. 2014-025346 filed Feb. 13, 2014.

### BACKGROUND

### Technical Field

The present invention relates to an image adjusting apparatus, an image forming apparatus, and a managing apparatus.

### SUMMARY

According to an aspect of the invention, there is provided an image adjusting apparatus, including:

an acceptable adjustment factor acquisition unit that acquires acceptable adjustment factors which are factors for adjusting an image forming unit and adjustment factors accepted to a user who performs an image adjustment;

an examination result acquisition unit that acquires an examination result of an image formed by the image forming unit; and

a real adjustment factor selection unit that selects real adjustment factors which are factors for actually performing an image adjustment with respect to the image forming unit among the acceptable adjustment factors based on the acquired examination result.

### BRIEF DESCRIPTION OF THE DRAWINGS

Exemplary embodiments of the present invention will be described in detail based on the following figures, wherein:

FIG. 1 is a diagram illustrating an entire configuration example of an image adjusting system to which the exemplary embodiment is applied;

FIG. 2 is a diagram illustrating a hardware configuration example of an image forming apparatus;

FIG. 3 is a diagram illustrating a hardware configuration of a management server;

FIG. 4A is a block diagram illustrating a functional configuration example of the image forming apparatus;

FIG. 4B is a block diagram illustrating a functional configuration example of a terminal apparatus;

FIG. 4C is a block diagram illustrating a functional configuration example of the management server;

FIG. 5A is a flowchart illustrating an operational example of the image adjusting system according to the exemplary embodiment;

FIG. 5B a flowchart illustrating an operational example of the image adjusting system according to the exemplary embodiment;

FIGS. 6A and 6B are diagrams illustrating a first example of a screen which is displayed on a display mechanism of the terminal apparatus according to the exemplary embodiment;

(a) and (b) of FIG. 7 are diagrams illustrating a first example of a screen which is displayed on a manipulation panel according to the exemplary embodiment;

FIGS. 8A and 8B are diagrams illustrating a second example of the screen which is displayed on the display mechanism of the terminal apparatus according to the exemplary embodiment;

(a) to (d) of FIG. 9 are diagrams illustrating a second example of the screen which is displayed on the manipulation panel according to the exemplary embodiment;

FIG. 10 is a diagram illustrating an example of a screen which is displayed on a display mechanism of a terminal apparatus of the related art; and
(a) and (b) of FIG. 11 are diagrams illustrating an example of a screen which is displayed on a manipulation panel of the related art.

### DETAILED DESCRIPTION

### Description of Entire Configuration of Image Adjusting System

Hereinafter, exemplary embodiments of the present invention will be described in detail with reference to the attached drawings.

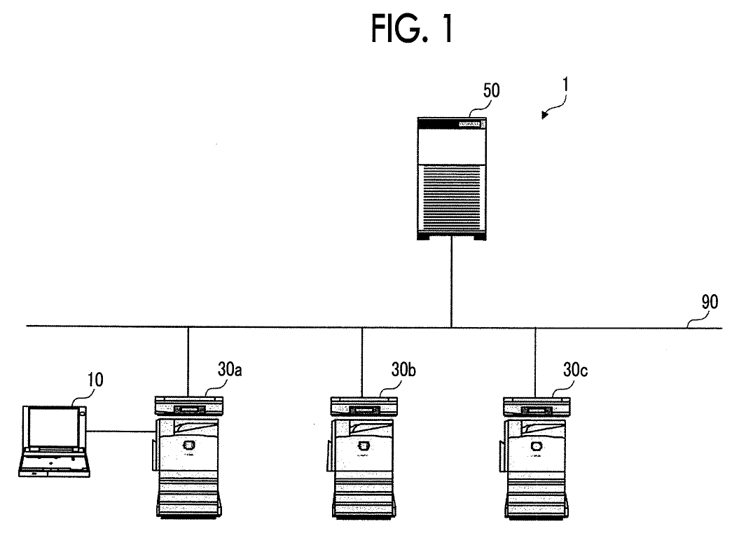

FIG. 1 is a diagram illustrating an entire configuration example of an image adjusting system to which the exemplary embodiment is applied.

As illustrated, in an image adjusting system 1, image forming apparatuses 30a, 30b, and 30c are connected to a network 90. In addition, a management server 50 as an example of a management unit (a managing apparatus), is connected to the network 90. Further, a terminal apparatus 10 as an example of an image adjustment unit (an image adjusting apparatus) is connected to the image forming apparatus 30a.

Furthermore, the image forming apparatuses 30a, 30b, and 30c are illustrated in the drawing, but when it is not necessary to discriminate the image forming apparatuses, it is referred to as “image forming apparatus 30”. In addition, only three image forming apparatuses 30 are illustrated in the drawing, but 4 or more image forming apparatuses 30 may be disposed.

The terminal apparatus 10 is a computer apparatus having a function of adjusting an image of the image forming apparatus 30a. The terminal apparatus 10 is connected to the image forming apparatus 30a, cooperates with the image forming apparatus 30a or the management server 50, and adjusts the image of the image forming apparatus 30a (the details will be described later). Here, as the terminal apparatus 10, for example, a Personal Computer (PC), a portable terminal such as a tablet, and a smart phone, and the like is able to be used.

The image forming apparatus 30 is an apparatus for forming an image on a recording material (paper), and outputting the recording material as a printing medium. Here, as the image forming apparatus 30, an apparatus only having a printer function may be used, and an apparatus having other image processing function such as a scanner function, a facsimile function in addition to the printer function may be used.

The management server 50 is a server computer for managing information related to the image forming apparatuses 30a, 30b, and 30c, information related to a user who performs an image adjustment, and the like through the network 90. A detailed configuration of the management server 50 will be described later.

The network 90 is a communication unit, for example, a Local Area Network (LAN), which is used in an information communication between the terminal apparatus 10 and the image forming apparatuses 30.

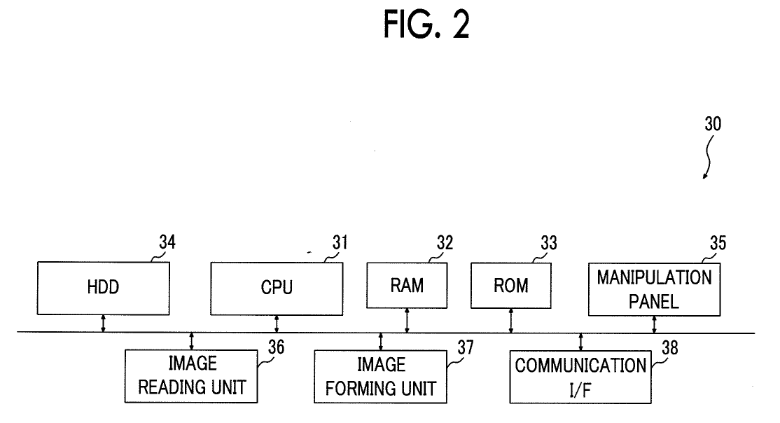

FIG. 2 is a diagram illustrating a hardware configuration example of the image forming apparatus 30.

As illustrated, the image forming apparatus 30 includes a Central Processing Unit (CPU) 31, a Random Access Memory (RAM) 32, a Read Only Memory (ROM) 33, a Hard Disk Drive (HDD) 34, a manipulation panel 35, an image reading unit 36, an image forming unit 37, and a communication interface (hereinafter, referred to as “communication I/F”) 38.

The CPU 31 loads various programs stored in the ROM 33 or the like to the RAM 32, and execute the programs, and thus realizes each function (described later).

The RAM 32 is a memory which is used as a working memory and the like of the CPU 31.

The ROM 33 is a memory which stores the various programs or the like executed by the CPU 31.

The HDD 34 is, for example, a magnetic disk apparatus which stores image data read out by the image reading unit 36, image data used for forming an image in the image forming unit 37, or the like.

The manipulation panel 35 is, for example, a touch panel which displays various information items or receives a manipulation input from the user.

The image reading unit 36 reads out an image recorded on a recording material such as a paper. Here, the image reading unit 36 is, for example, a scanner, and may use a CCD method in which Charge Coupled Devices (CCDs) receive reflection light with respect to light applied to a document from a light source by focusing the light on a lens, or a CIS method in which a Contact Image Sensor (CIS) receives reflection light with respect to light sequentially applied to a document from an LED light source.

The image forming unit 37 is a printing mechanism which forms an image on a recording material. Here, the image forming unit 37 is, for example, a printer, and may use an electrophotographic method which forms an image by transferring a toner attached to a photoreceptor to the recording material, or an inkjet method which forms an image by ejecting ink on the recording material.

The communication I/F 38 transmits and receives various information items with respect to other apparatus through the network.

Next, a hardware configuration of the management server 50 will be described.

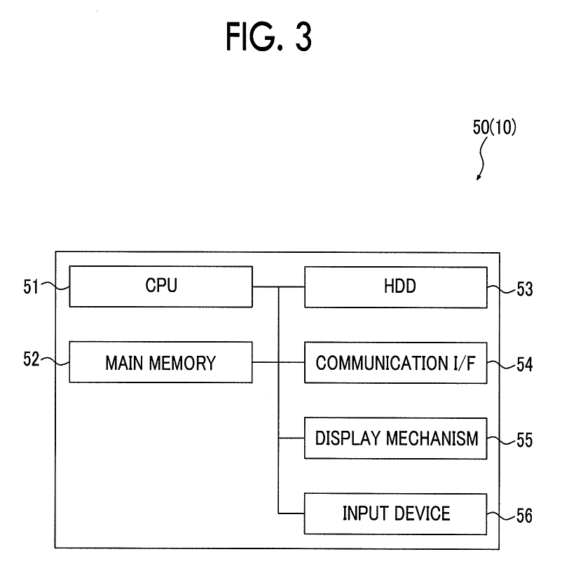

FIG. 3 is a diagram illustrating a hardware configuration of the management server 50.

As illustrated, the management server 50 includes a CPU 51 which is a computing unit, a main memory 52 and an HDD 53 which are a storage unit. Here, the CPU 51 executes an Operating System (OS) or various software items such as an application, and realizes each function (described later). In addition, the main memory 52 is a storage region which stores the various software items, data used for an execution thereof, or the like, and the HDD 53 is a storage region which stores input data with respect to the various software items, output data from the various software items, or the like.

Further, the management server 50 includes a communication I/F 54 for communicating with an outside device, a display mechanism 55 including a video memory, a display, or the like, and an input device 56 such as a keyboard, and a mouse.

Furthermore, a hardware configuration of the terminal apparatus 10 is identical to the configuration of FIG. 3. Accordingly, hereinafter, when the hardware configuration of the terminal apparatus 10 is described, the CPU 51, the main memory 52, the HDD 53, the communication I/F 54, the display mechanism 55, and the input device 56 are used.

Here, when the image of the image forming apparatus 30 is adjusted, it is general that factors which are able to be adjusted or an adjustment amount is uniformly fixed in advance in the related art. In this regard, an adjustable range is changed according to a state of a chart for an adjustment or a current adjustment value in the image forming apparatus.

However, image adjustment factors are various and different for each image forming apparatus 30. Further, it is difficult for an ordinary user to grasp content of the factor. Further, it is also difficult to select a suitable factor among the image adjustment factors, and to adjust the factor by a suitable adjustment amount.

On the other hand, there is a method which calls a service engineer, and adjusts the image of the image forming apparatus 30. However, in this method, it is necessary to wait for the service engineer to arrive, and thus a lot of time is required. Further, adjustment cost is necessary, and thus there is a problem of increasing operational cost of the image forming apparatus 30.

In the exemplary embodiment, the image adjusting system 1 includes the following configuration in order to have small necessities for calling the service engineer and to more easily adjust the image of the image forming apparatus 30 by the user.

Description of Functional Configuration of Image Adjusting System

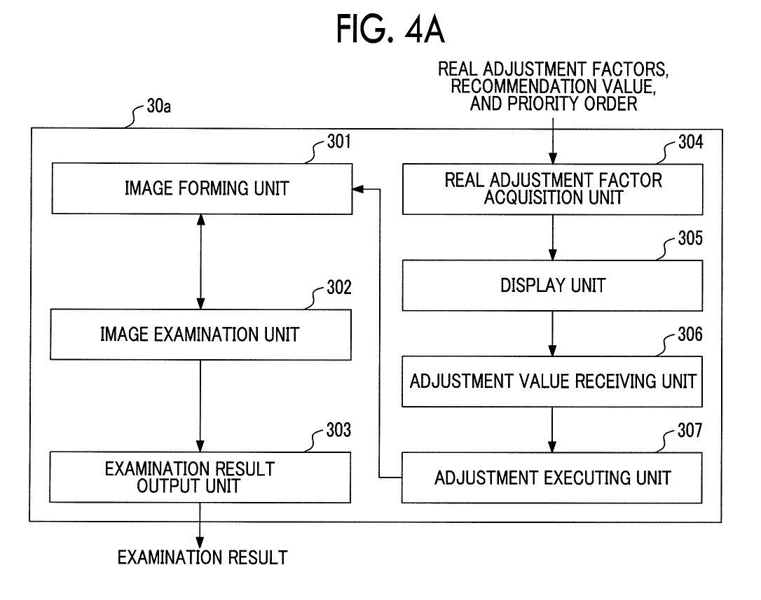

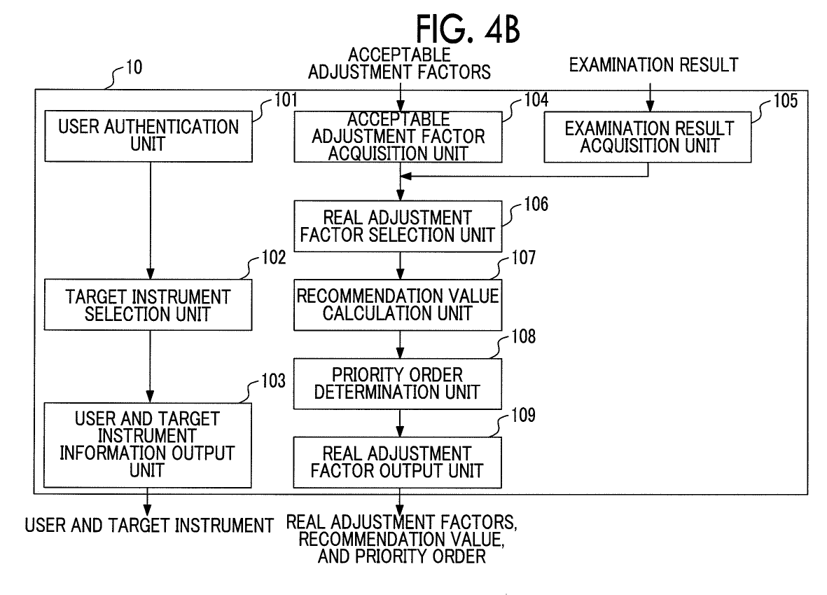

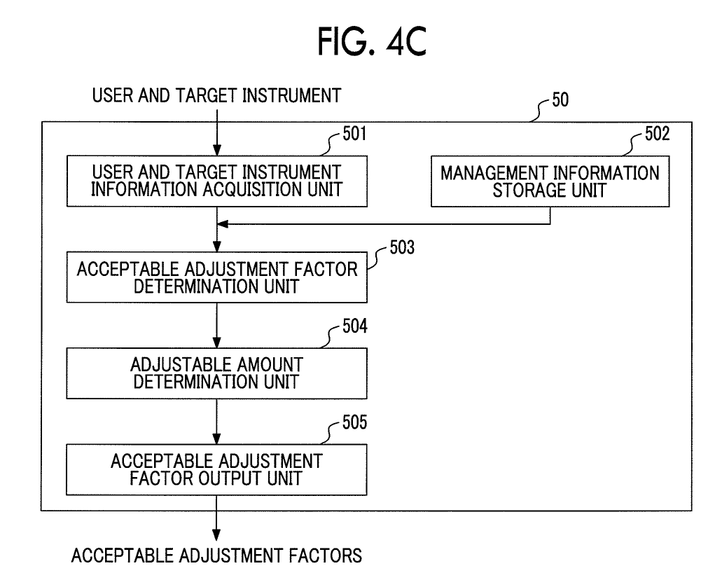

FIG. 4A to FIG. 4C are block diagrams illustrating each functional configuration example of the image forming apparatus 30a, the terminal apparatus 10, and the management server 50 which configure the image adjusting system 1. Among FIG. 4A to FIG. 4C, FIG. 4A illustrates a functional configuration example of the image forming apparatus 30a. In addition, FIG. 4B illustrates a functional configuration example of the terminal apparatus 10, and FIG. 4C illustrates a functional configuration example of the management server 50. Furthermore, here, for the sake of easy description, only the image forming apparatus 30a among the image forming apparatuses 30 is illustrated, and a case where an image adjustment is performed with respect to the image forming apparatus 30a is illustrated. However, when the terminal apparatus 10 is connected, the same image adjustment is also able to be performed with respect to the other image forming apparatuses 30b and 30c. In addition, in FIG. 4A to FIG. 4C, the illustration is limited to a function related to the exemplary embodiment among the various functions which are provided in the terminal apparatus 10, the image forming apparatus 30a, and the management server 50.

The image forming apparatus 30a includes an image forming unit 301, an image examination unit 302, an examination result output unit 303, a real adjustment factor acquisition unit 304, a display unit 305, an adjustment value receiving unit 306, and an adjustment executing unit 307.

The image forming unit 301 is a printing mechanism unit for forming an image on a recording material. That is, in the example of FIG. 2, the image forming unit 301 corresponds to the image forming unit 37.

The image examination unit 302 examines an image formed on a recording material by the image forming unit 301. In practice, a management chart for an image examination is printed on the recording material, and the management chart is read out by an image reading sensor or the like (not illustrated). Then, the image examination unit 302 examines the image based on image data acquired therefor. In the example of FIG. 2, the image examination unit 302 corresponds to the CPU 31.

The examination result output unit 303 outputs information of an examination result examined by the image examination unit 302 to the terminal apparatus 10. In the example of FIG. 2, the examination result output unit 303 corresponds to the communication I/F 38.

The real adjustment factor acquisition unit 304 acquires real adjustment factors which are image adjustment factors with respect to the image forming unit 301, but the details will be described later. In addition, the real adjustment factor acquisition unit 304 further acquires a recommendation value of the adjustment with respect to the real adjustment factors and a priority order of the real adjustment factors, but the details will be described later. In the example of FIG. 2, the real adjustment factor acquisition unit 304 corresponds to the communication I/F 38.

The display unit 305 displays real adjustment factors which are image adjustment factors with respect to the image forming unit 301, but the details will be described later. In the example of FIG. 2, the display unit 305 corresponds to the manipulation panel 35.

The adjustment value receiving unit 306 receives an adjustment value input by a user based on the real adjustment factors displayed on the display unit 305. In the example of FIG. 2, the adjustment value receiving unit 306 corresponds to the manipulation panel 35.

The adjustment executing unit 307 adjusts an image of the image forming unit 301 based on the adjustment value with respect to each real adjustment factor input by a user. In the example of FIG. 2, the adjustment executing unit 307 corresponds to the CPU 31.

The terminal apparatus 10 includes an user authentication unit 101, a target instrument selection unit 102, a user and target instrument information output unit 103, an acceptable adjustment factor acquisition unit 104, an examination result acquisition unit 105, a real adjustment factor selection unit 106, a recommendation value calculation unit 107, a priority order determination unit 108, and a real adjustment factor output unit 109.

The user authentication unit 101 authenticates the user who performs an image adjustment of the image forming apparatus 30a.

In addition, the target instrument selection unit 102 selects a target instrument in which the image adjustment is performed. In this case, the target instrument is the image forming apparatus 30a.

In the example of FIG. 3, the user authentication unit 101 and the target instrument selection unit 102 correspond to the CPU 51, the display mechanism 55, and the input device 56. In this case, an input of a user ID or the like or a window for selecting the target instrument, and the like are displayed on the display mechanism 55. Then, the user performs the input by using the input device 56. Accordingly, the user authentication unit 101 specifies the user, and the target instrument selection unit 102 specifies the target instrument.

The user and target instrument information output unit 103 outputs information of the specified user or information of the target instrument to the management server 50. Specifically, the information of the user is, for example, a user ID, and the information of the target instrument is, for example, an instrument No. of the image forming apparatus 30a.

The acceptable adjustment factor acquisition unit 104 acquires acceptable adjustment factors which are possible in the image forming unit 301 as an image adjustment target, and are image adjustment factors accepted to the user who performs the image adjustment. That is, the acceptable adjustment factor acquisition unit 104 acquires the acceptable adjustment factors which are factors for adjusting the image forming unit 301, and adjustment factors accepted to the user who performs the image adjustment.

In the example of FIG. 3, the user and target instrument information output unit 103, and the acceptable adjustment factor acquisition unit 104 correspond to the communication I/F 54.

The image adjustment factors are different for each of the image forming apparatuses 30, and thus the image adjustment factors which are possible in the image forming unit 301 of the image forming apparatus 30a first exist.

In addition, ability for performing the image adjustment is different with respect to each user who performs an image adjustment. For this reason, the user with high ability for the image adjustment skillfully uses a lot of factors among the image adjustment factors which are possible in the image forming apparatus 30a, but the user with low ability for the image adjustment narrowly uses the factors among the image adjustment factors which are possible in the image forming apparatus 30a. Further, a difficulty level of the image adjustment is different for each of the image forming apparatuses 30. For this reason, according to the ability of the user or the difficulty level of the image adjustment for each instrument, the image adjustment factors which are accepted according to the difficulty level of the image adjustment for each user or each instrument are selected from the image adjustment factors which are possible in the image forming apparatus 30a, and the acceptable adjustment factor acquisition unit 104 acquires the acceptable adjustment factors which are the accepted image adjustment factors. In addition, at this time, the acceptable adjustment factor acquisition unit 104 also acquires an adjustable amount as an amount which is able to be adjusted with respect to each of the acceptable adjustment factors, but the details will be described later.

The management server 50 selects the acceptable adjustment factors based on the information of the user or the target instrument which is output by the user and target instrument information output unit 103, but the details will be described later.

The examination result acquisition unit 105 acquires the examination result of the image formed by the image forming unit 301. That is, the examination result acquisition unit 105 acquires information of the examination result which is output by the examination result output unit 303 of the image forming apparatus 30a. In the example of FIG. 3, the examination result acquisition unit 105 corresponds to the communication I/F 54.

The real adjustment factor selection unit 106 selects the real adjustment factors which are the factors for actually performing the image adjustment with respect to the image forming unit 301 among the acceptable adjustment factors based on the examination result acquired by the examination result acquisition unit 105. That is, the factors for the image adjustment which is performed with respect to the image forming unit 301 according to the examination result, are able to be determined. Accordingly, the real adjustment factor selection unit 106 selects the real adjustment factors as the factors for actually performing the image adjustment with respect to the image forming unit 301 among the acceptable adjustment factors. Specifically, the real adjustment factor selection unit 106 compares an originally existing target value and the examination result, and when the difference exceeds a predetermined threshold value, the real adjustment factors are selected according to the examination result.

The recommendation value calculation unit 107 obtains the recommendation value of the adjustment with respect to the real adjustment factors selected by the real adjustment factor selection unit 106. Specifically, the recommendation value calculation unit 107 compares the examination result and the originally existing target value, and thus calculates the recommendation value of the adjustment which is required to be the target value.

The priority order determination unit 108 determines the priority order required for the image adjustment of the image forming unit 301 among the real adjustment factors selected by the real adjustment factor selection unit 106. That is, when there are plural real adjustment factors, there may be image adjustment factors which should be preferentially performed among the plural real adjustment factors. For this reason, when there are the plural real adjustment factors, the priority order determination unit 108 determines the sequence of the adjustment.

In the example of FIG. 3, the real adjustment factor selection unit 106, the recommendation value calculation unit 107, and the priority order determination unit 108 which are described above correspond to the CPU 51.

The real adjustment factor output unit 109 outputs each information item of the selected real adjustment factors, the recommendation value, and the priority order of the real adjustment factors to the real adjustment factor acquisition unit 304 of the image forming apparatus 30a. In the example of FIG. 3, the real adjustment factor output unit 109 corresponds to the communication I/F 54.

The management server 50 includes a user and target instrument information acquisition unit 501, a management information storage unit 502, an acceptable adjustment factor determination unit 503, an adjustable amount determination unit 504, and an acceptable adjustment factor output unit 505.

The user and target instrument information acquisition unit 501 acquires the information of the user and the information of the image forming apparatus 30a as the target instrument which are output from the user and target instrument information output unit 103 of the terminal apparatus 10. In the example of FIG. 3, the user and target instrument information acquisition unit 501 corresponds to the communication I/F 54.

The management information storage unit 502 stores the information related to the user or the target instrument. Specifically, the management information storage unit 502 stores the information of the image adjustment factors which are possible in the image forming unit 301, and the user ID as the information of the user who performs the image adjustment. In the example of FIG. 3, the management information storage unit 502 corresponds to the main memory 52 or the HDD 53.

Then, the acceptable adjustment factor determination unit 503 acquires the image adjustment factors which are possible in the image forming apparatus 30a from the information of the target instrument with reference to the management information storage unit 502. Then, the acceptable adjustment factor determination unit 503 further determines the acceptable adjustment factors which are the image adjustment factors accepted to the user among the image adjustment factors which are possible in the image forming apparatus 30a based on the information of the user stored in the management information storage unit 502. In addition, at this time, the acceptable adjustment factors may be determined by adding the difficulty level of the image adjustment of the image forming apparatus 30a.

The adjustable amount determination unit 504 determines the adjustable amount which is able to be adjusted with respect to the determined acceptable adjustment factors. It is preferable that the adjustable amount be changed by the user. That is, the adjustable amount is to be large for the user with high ability of the image adjustment, and the adjustable amount is to be small for the user with low ability of the image adjustment. That is, the adjustable amount determination unit 504 determines the adjustable amount which is able to be adjusted with respect to the acceptable adjustment factors based on the information of the user stored in the management information storage unit 502. In addition, the adjustable amount may be determined by further adding the difficulty level of the image adjustment of the image forming apparatus 30a. By setting the adjustable amount according to the ability of the user or the difficulty level of the image adjustment for each of the image forming apparatuses 30, it is possible to inhibit the image adjustment from failing.

In the example of FIG. 3, the acceptable adjustment factor determination unit 503, and the adjustable amount determination unit 504 correspond to the CPU 51.

The acceptable adjustment factor output unit 505 outputs the information of the acceptable adjustment factors determined by the acceptable adjustment factor determination unit 503, and the information of the adjustable amount determined by the adjustable amount determination unit 504 to the acceptable adjustment factor acquisition unit 104 of the terminal apparatus 10. In the example of FIG. 3, the acceptable adjustment factor output unit 505 corresponds to the communication I/F 54.

Description of Operation of Image Adjusting System

Next, an operation of the image adjusting system 1 according to the exemplary embodiment will be described.

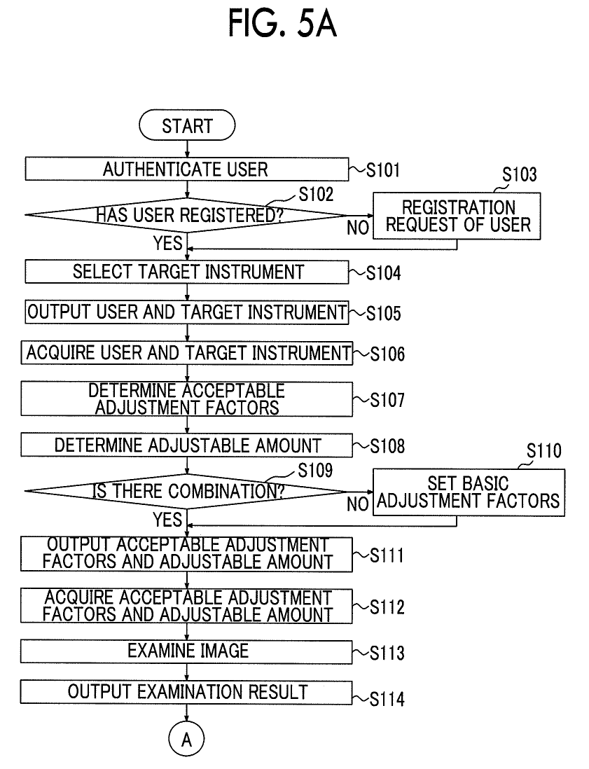

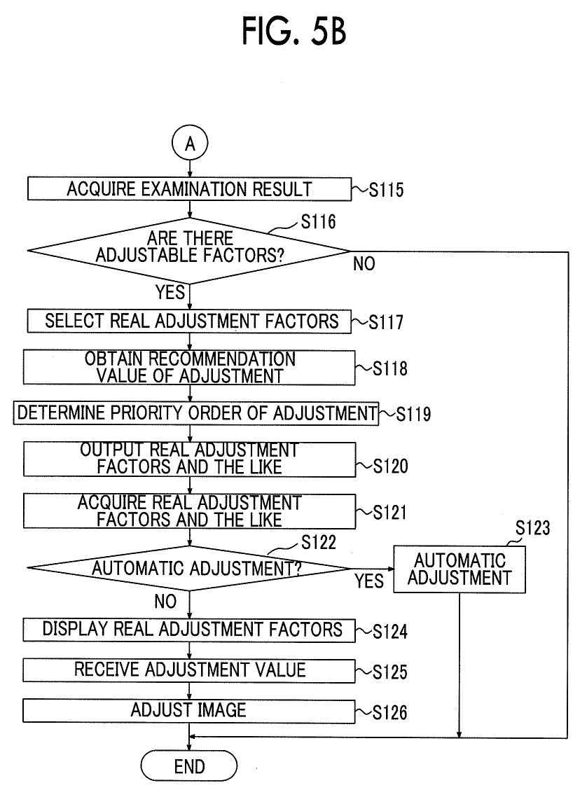

FIG. 5A and FIG. 5B are flowcharts illustrating an operational example of the image adjusting system 1 according to the exemplary embodiment. Hereinafter, an operation of the image adjusting system 1 will be described with reference to FIG. 4A to FIG. 4C, and FIG. 5A and FIG. 5B.

First, the user authentication unit 101 of the terminal apparatus 10 authenticates the user according to the input of the user who performs the image adjustment (Step 101).

At this time, the user authentication unit 101 determines whether or not the input user is a registered user (Step 102).

Then, when the user is registered (Yes in Step 102), the procedure proceeds to the process of Step 104. On the other hand, when the user is not registered (No in Step 102), the user authentication unit 101 performs a registration request of the user, and performs a registration of the user (Step 103).

Next, the target instrument selection unit 102 selects the image forming apparatus 30a as the target instrument according to the input of the user (Step 104).

Further, the user and target instrument information output unit 103 outputs the information of the user or the information of the image forming apparatus 30a which is the target instrument to the management server 50 (Step 105).

Then, the user and target instrument information acquisition unit 501 of the management server 50 acquires the output information of the user and information of the image forming apparatus 30a which is the target instrument (Step 106).

Next, the acceptable adjustment factor determination unit 503 determines the acceptable adjustment factors based on the information registered with respect to the user and the image forming apparatus 30a with reference to the management information storage unit 502 (Step 107).

At this time, as described above, the acceptable adjustment factors are determined according to the ability of the user. In addition, it is preferable that the acceptable adjustment factors be determined by adding the difficulty level of the image adjustment of the image forming apparatus 30a.

Next, the adjustable amount determination unit 504 determines the adjustable amount which is able to be adjusted with respect to the determined acceptable adjustment factors (Step 108). The adjustable amount is changed by the user as described above, and determined according to the ability of the user. In addition, it is preferable that the adjustable amount be determined by adding the difficulty level of the image adjustment of the image forming apparatus 30a.

In addition, in the management information storage unit 502, information with respect to a combination of the user and the image forming apparatus 30a is stored, and the acceptable adjustment factor determination unit 503 determines whether or not there is the combination (Step 109). That is, levels of the ability to be able to adjust the image for each of the image forming apparatuses 30 by each user are different. For this reason, the combination of the user and each of the image forming apparatuses 30 is prepared, and when there is the combination, the accepted image adjustment factors are large for the user, and when there is no combination, only basic image adjustment factors (basic management factors) are accepted, and thus the accepted image adjustment factors are minimized. That is, when there is the combination, the ability of the user who performs the image adjustment with respect to the image forming apparatus 30a may be high, and when there is no combination, the ability of the user who performs the image adjustment with respect to the image forming apparatus 30a may be low. The combination may be set in advance, and for example, the management server 50 may set the combination according to an actual achievement or the like for adjusting the image of each of the image forming apparatuses 30 by the user in the past.

Then, when there is the combination (Yes in Step 109), the acceptable adjustment factors determined in Step 107 are maintained, and the procedure proceeds to the process of Step 111. On the other hand, when there is no combination (No in Step 109), minimum basic adjustment factors are set as the acceptable adjustment factors (Step 110).

Next, the acceptable adjustment factor output unit 505 outputs information of the acceptable adjustment factors and the adjustable amount to the terminal apparatus 10 (Step 111).

Then, the acceptable adjustment factor acquisition unit 104 of the terminal apparatus 10 acquires the information of the output acceptable adjustment factors and adjustable amount (Step 112).

On the other hand, the image examination unit 302 of the image forming apparatus 30a prints the management chart on a recording material by the image forming unit 301, and examines the image formed on the recording material (Step 113).

Further, the examination result output unit 303 outputs the information of the examined examination result to the terminal apparatus 10 (Step 114). Furthermore, the examination result output unit 303 may output the examination result to the management server 50, and may store the result as a history in the management information storage unit 502 of the management server 50.

The examination result acquisition unit 105 of the terminal apparatus 10 acquires the information of the examination result (Step 115).

Next, the real adjustment factor selection unit 106 determines whether or not there are adjustable factors in the acceptable adjustment factors based on the acquired examination result (Step 116).

Then, when there is no adjustable factor (No in Step 116), a series of processes is ended. On the other hand, when there are the adjustable factors (Yes in Step 116), the real adjustment factor selection unit 106 selects the real adjustment factors which are factors for actually performing the image adjustment with respect to the image forming unit 301 among the acceptable adjustment factors (Step 117).

Further, the recommendation value calculation unit 107 obtains the recommendation value of the adjustment with respect to the selected real adjustment factors (Step 118).

In addition, the priority order determination unit 108 determines the priority order required for the image adjustment of the image forming unit 301 among the selected real adjustment factors (Step 119).

Then, the real adjustment factor output unit 109 outputs each information item of the selected real adjustment factors, the recommendation value, and the priority order of the real adjustment factors to the image forming apparatus 30a (Step 120).

The real adjustment factor acquisition unit 304 of the image forming apparatus 30a acquires each of the information items (Step 121).

At this time, it is also considered that the image adjustment of the image forming apparatus 30a is set to be automatically performed. Accordingly, in the exemplary embodiment, the adjustment executing unit 307 determines whether or not the image adjustment is set to be automatically performed (Step 122).

Then, when the image adjustment is set to be automatically performed (Yes in Step 122), the adjustment executing unit 307 automatically performs the image adjustment based on each of the information items of the real adjustment factors, the recommendation value, and the priority order of the real adjustment factors which are acquired in Step 121 (Step 123).

On the other hand, when the image adjustment is not set to be automatically performed (No in Step 122), that is, when the image adjustment is set to be manually performed, the procedure proceeds to the process of Step 124.

In this case, the display unit 305 displays the real adjustment factors (Step 124), and the adjustment value receiving unit 306 receives the adjustment value input by the user (Step 125).

Further, the adjustment executing unit 307 performs the image adjustment of the image forming unit 301 based on the adjustment value with respect to each of the real adjustment factors input by the user (Step 126). At this time, the image adjustment is performed according to the priority order determined in Step 119.

Description of Screen Displayed on Display Mechanism of Terminal Apparatus and Manipulation Panel

At this time, it is preferable that a message related to the image adjustment be displayed on the display mechanism 55 of the terminal apparatus 10 for the user. In addition, functions of the display unit 305 of the image forming apparatus 30a and the adjustment value receiving unit 306 correspond to a function of the manipulation panel 35 as described above, and in the exemplary embodiment, the manipulation panel 35 displays the real adjustment factors or receives the adjustment value.

Hereinafter, an example of the image, displayed on the display mechanism 55 of the terminal apparatus 10 and the display unit 305 of the image forming apparatus 30a, will be described.

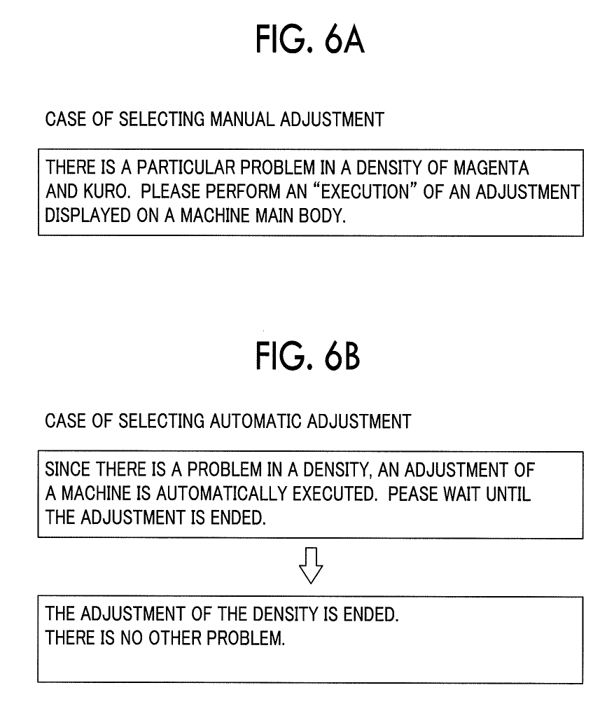

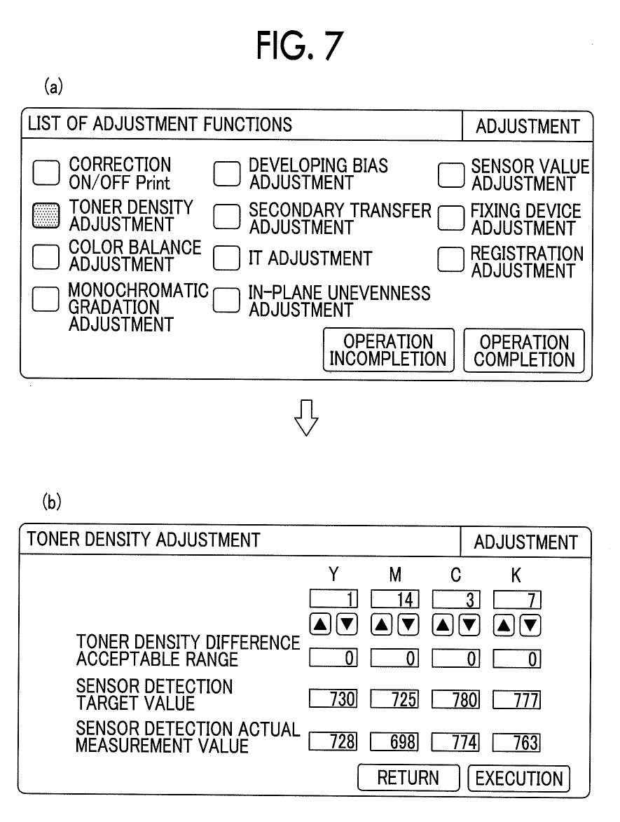

FIGS. 6A and 6B are diagrams illustrating a first example of a screen which is displayed on the display mechanism 55 of the terminal apparatus 10 according to the exemplary embodiment.

Among FIGS. 6A and 6B, FIG. 6A illustrates a message which is displayed when the image adjustment is manually performed. A message to the effect that there is a problem in a color density of “Magenta” and “Kuro (black)” as a toner when the image forming apparatus 30a is in an electrophotographic method, and a message to the effect of prompting for the adjustment on the image forming apparatus 30a side are notified to the user.

In addition, FIG. 6B illustrates a message which is displayed when the image adjustment is automatically performed. In this case, an upper side message of FIG. 6B is first displayed, and the message to the effect that there is a problem in the color density and a message to the effect of automatically performing the image adjustment are notified to the user. In addition, when the automatic adjustment is ended, a lower side message of FIG. 6B is displayed. A message to the effect that the adjustment of the density is ended and a message to the effect that there is no other problem are notified to the user.

In addition, (a) and (b) of FIG. 7 are diagrams illustrating a first example of a screen which is displayed on the manipulation panel 35 according to the exemplary embodiment.

Among (a) and (b) of FIG. 7, (a) of FIG. 7 illustrates a screen on which the real adjustment factors are displayed in Step 124 described above. Then, here, a case where a “toner density adjustment” is selected as the real adjustment factor, and the other image adjustment factors are not selected, is illustrated.

In this case, as illustrated, the “toner density adjustment” as the real adjustment factor is displayed in a high density, and the other image adjustment factors are displayed in a low density. Further, the user is able to select only the “toner density adjustment” in the manipulation panel 35 by touching the “toner density adjustment”, and the other factors do not react even when the factors are touched. That is, the real adjustment factors are discriminated from the other factors and displayed on the manipulation panel 35.

Then, when the user actually touches the “toner density adjustment”, the screen is switched into a screen of (b) of FIG. 7.

(b) of FIG. 7 illustrates a screen which receives the adjustment value input by the user in Step 125 described above.

Here, a color of the toner formed by the image forming apparatus 30a is displayed as yellow (Y), magenta (M), cyan (C), and black (K) on a first line which is an uppermost stage. Further, in a fifth line and a sixth line, a target value of the toner density and an actual measurement value of the toner density for each Y, M, C, and K are displayed as a “sensor detection target value” and a “sensor detection actual measurement value”, respectively. Further, in a fourth line, a state where the “toner density difference acceptable range” is “0” for each color is displayed.

In addition, in a second line, with respect to each Y, M, C, and K, the recommendation value of the adjustment which is obtained by the recommendation value calculation unit 107 in the Step 118 described above is displayed as an initial value.

At this time, the user touches symbols “▴” and “▾” in the third line, and thus is able to increase or decrease a numerical value of the second line. That is, the numerical value increases one by one by touching the symbol “▴”, and the numerical value decreases one by one by touching the symbol “▾”. Accordingly, the user is able to input the adjustment value for which the user desires to set. Furthermore, the numerical value is able to be increased or decreased only within a range of the adjustable amount determined in Step 108.

Then, when the user touches an “execution” in a lower right side of the screen after setting the adjustment value, the image adjustment of the image forming unit 301 described in Step 126 is performed based on the adjustment value.

Furthermore, in this case, the recommendation value is initially displayed in the first line, and thus when the user desires to perform the image adjustment according to the recommendation value, the user may touch the “execution” without increasing or decreasing the numerical value of the first line.

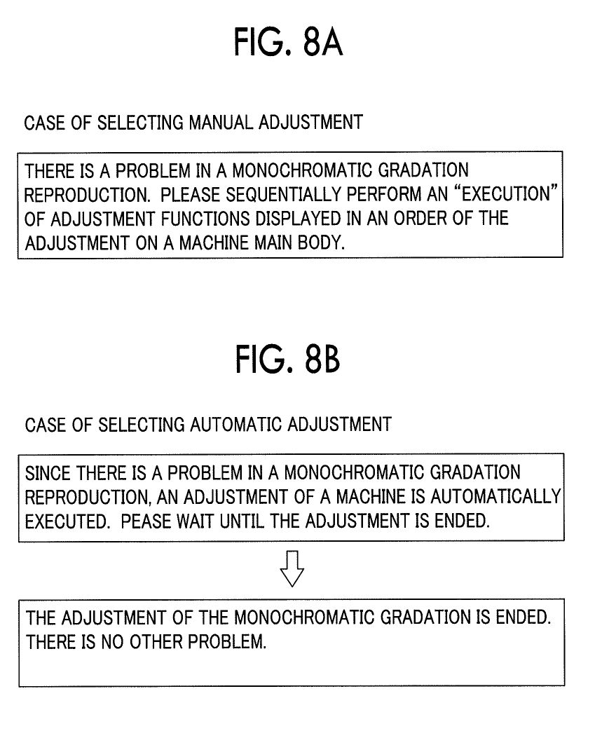

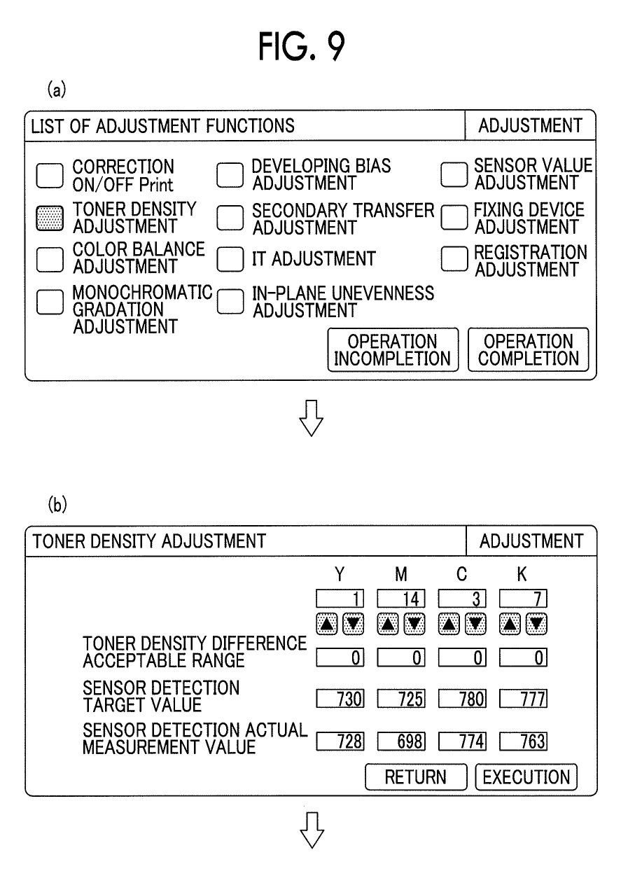

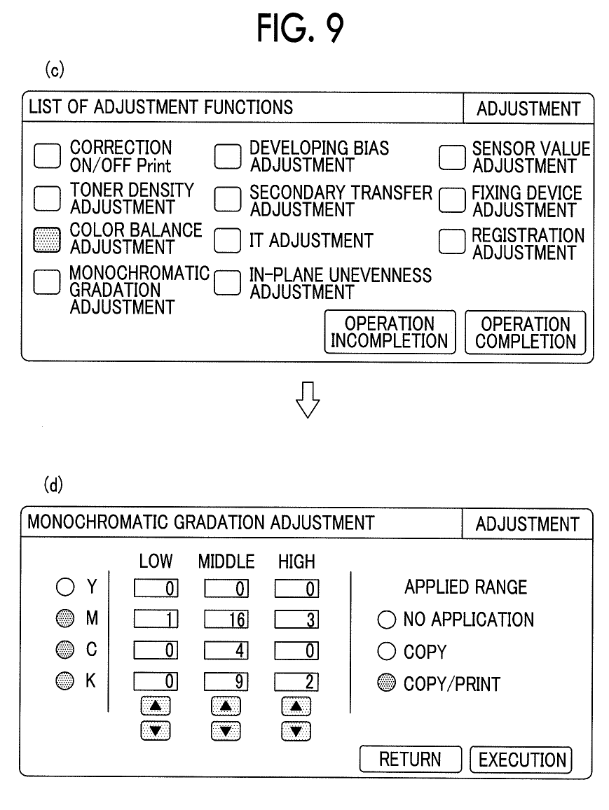

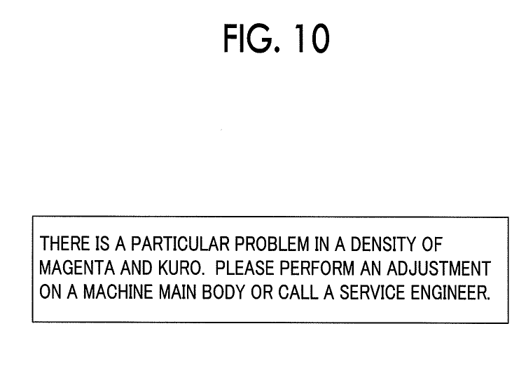

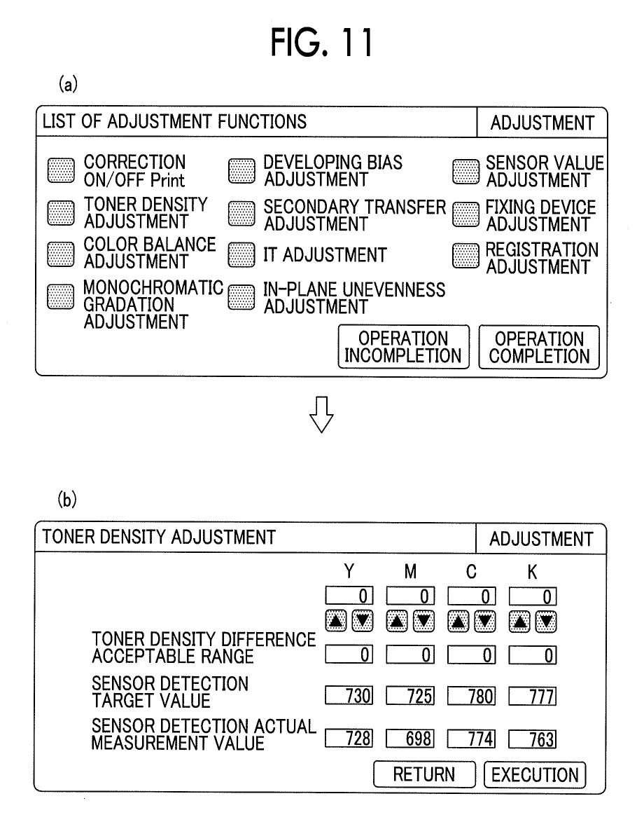

In addition, FIGS. 8A and 8B are diagrams illustrating a second example of the screen which is displayed on the display mechanism 55 of the terminal apparatus 10 according to the exemplary embodiment.

Among FIGS. 8A and 8B, FIG. 8A illustrates a message which is displayed when the image adjustment is manually performed. The message to the effect that there is a problem in a monochromatic gradation reproduction and a message to the effect of prompting for sequentially performing the “execution” of adjustment functions displayed in an order of the adjustment on the image forming apparatus 30a side are notified to the user.

In addition, FIG. 8B illustrates a message which is displayed when the image adjustment is automatically performed. In this case, an upper side message of FIG. 8B is first displayed, and the message to the effect that there is a problem in the monochromatic gradation reproduction and a message to the effect of automatically performing the image adjustment are notified to the user. In addition, when the automatic adjustment is ended, a lower side message of FIG. 8B is displayed. A message to the effect that the adjustment of the monochromatic gradation reproduction is ended and a message to the effect that there is no other problem are notified to the user.

In addition, (a) to (d) of FIG. 9 are diagrams illustrating a second example of the screen which is displayed on the manipulation panel 35 according to the exemplary embodiment.

When there is a problem in the monochromatic gradation reproduction, the real adjustment factor selection unit 106 selects two real adjustment factors of the “toner density adjustment” and a “color balance adjustment” as the real adjustment factors in Step 117 described above. Then, in Step 119 described above, the priority order determination unit 108 determines that the “toner density adjustment” has priority as the priority order required for performing the image adjustment of the image forming unit 301, and determines that the image adjustment of the image forming unit 301 is performed in an order of the “toner density adjustment” and the “color balance adjustment”. For this reason, in (a) to (d) of FIG. 9, the image adjustment is performed in this order.

(a) of FIG. 9 illustrates a screen for displaying the real adjustment factors. Then, here, a case where the “toner density adjustment” is first selected as the real adjustment factor, and the other image adjustment factors are not selected is illustrated. In this case, the user is only able to select the “toner density adjustment” in the manipulation panel 35.

Then, when the user actually touches the “toner density adjustment”, the screen is switched to a screen of (b) of FIG. 9.

(b) of FIG. 9 illustrates a screen which receives the adjustment value input by the user with respect to the “toner density adjustment”.

Here, the displayed screen is identical to the screen of (b) of FIG. 7. The color of the toner formed by the image forming apparatus 30a is displayed in the first line which is the uppermost stage, and the recommendation value for each Y, M, C, and K is displayed in the second line as the initial value. Further, in the third line, the symbols “▴” and “▾” for inputting the adjustment value by the user are displayed. Then, in the fourth line to the sixth line, the “toner density difference acceptable range”, the “sensor detection target value”, and the “sensor detection actual measurement value” for each Y, M, C, and K are displayed, respectively.

Then, when the user touches the “execution” in the lower right side of the screen after setting the adjustment value, a screen of (c) of FIG. 9 is displayed.

(c) of FIG. 9 illustrates a screen for displaying the real adjustment factors which are identical to the real adjustment factors of (a) of FIG. 9. Then, here, a case where the “color balance adjustment” is selected as the real adjustment factor, and the other image adjustment factors are not selected is illustrated. In this case, the user is only able to select the “color balance adjustment” in the manipulation panel 35.

Then, when the user actually touches the “color balance adjustment”, the screen is switched to a screen of (d) of FIG. 9.

(d) of FIG. 9 illustrates a screen which receives the adjustment value input by the user with respect to the “color balance adjustment”.

Here, the color of the toner formed by the image forming apparatus 30a is displayed as Y, M, C, and K in a first column of a leftmost side.

Then, a second column is a portion in which the adjustment value for adjusting the color balance for Y, M, C, and K in a low density region is input.

Similarly, a third column is a portion in which the adjustment value for adjusting the color balance for Y, M, C, and K in a middle density region is input. Further, a fourth column is a portion in which the adjustment value for adjusting the color balance for Y, M, C, and K in a high density region is input.

Here, in the second column to the fourth column, the recommendation value for each Y, M, C, and K which is obtained by the recommendation value calculation unit 107 in Step 118 described above is displayed as the initial value.

Then, in a. lower side of the second column to the fourth column, the symbols “▴” and “▾” are displayed, and the displayed value is increased or decreased by the symbols, and thus it is possible to input the adjustment value.

Specifically, for example, when the user desires to input the adjustment value with respect to the low density region of magenta (M), the user first touches a radio button of a portion where of the first column is displayed. Accordingly, the magenta (M) is first selected. Then, by touching the symbols “▴” and “▾” in a lower side of the second column, the numerical value “1” which is displayed as the recommendation value increases or decreases, and the user is able to set a desired adjustment value.

Then, when the user touches the “execution” in the lower right side of the screen after setting the adjustment value, the image adjustment of the image forming unit 301 described in Step 126 is performed based on the adjustment value set in (b) of FIG. 9 and (d) FIG. 9.

FIG. 10 is a diagram illustrating an example of a screen which is displayed on the display mechanism 55 of the terminal apparatus 10 of the related art.

As illustrated, in this case, a message to the effect that there is a problem in a color density of “Magenta” and “Kuro (black)” as a toner, and a message to the effect of prompting for performing the adjustment on the image forming apparatus 30a side or for calling a service engineer are notified to the user.

In addition, (a) and (b) of FIG. 11 are diagrams illustrating an example of a screen which is displayed on the manipulation panel 35 of the related art.

Among (a) and (b) of FIG. 11, (a) of FIG. 11 illustrates a screen for displaying the image adjustment factors. In this example, since the image adjustment factors are not selected according to the ability of the user or the difficulty level of the image adjustment of the image forming apparatus 30a, in the screen of (a) of FIG. 11, the user is able to select all of the image adjustment factors by touching unlike the screen of (a) of FIG. 7.

Then, when the user touches, for example, the “toner density adjustment”, the screen is switched to a screen of (b) of FIG. 11.

(b) of FIG. 11 illustrates a screen of the related art which receives the adjustment value input by the user.

The screen of (b) of FIG. 11 does not display the recommendation value in the first line which is the uppermost stage compared to the screen of (b) of FIG. 7, and the numerical value “0” is displayed as the initial value. Then, the user touches the symbols “▴” and “▾” in the third line, and increases or decreases the numerical value in the second line, and thus inputs the adjustment value.

When the example of the exemplary embodiment illustrated in FIG. 6A to (b) of FIG. 7 and the example of the related art illustrated in FIG. 10 to (b) of FIG. 11 are compared, in the example of the exemplary embodiment, factors which are coincident with the ability of the user or the difficulty level of the image adjustment of the image forming apparatus 30a are specified as the factors which are able to perform the image adjustment and displayed on the manipulation panel 35, compared to the example of the related art. Accordingly, the user is able to easily grasp the image adjustment factors which are able to be manipulated according to the ability of the user or the difficulty level of the image adjustment of the image forming apparatus 30a. Further, it is difficult to select error factors or to miss the adjustment, and thus it is difficult to fail the image adjustment.

In addition, in the example of the exemplary embodiment, the recommendation value is displayed with respect to each real adjustment factor. For this reason, the user easily grasps how to set an adjustment direction, the adjustment value, or the like, and for example, even when the user with low ability performs the image adjustment, the image adjustment becomes easier. Further, in the example of the exemplary embodiment, the adjustable amount is set with respect to each of the real adjustment factors, and the adjustable amount is coincident with the ability of the user or the difficulty level of the image adjustment of the image forming apparatus 30a, and thus, for example, even when the user with low ability performs the image adjustment, it is difficult to fail the image adjustment.

On the other hand, in the example of the related art, it is not easy to grasp which image adjustment factors have an effective adjustment function. Further, even when the image adjustment factors are grasped, it is not easy to determine how to set a suitable adjustment amount.

Thus, the user is able to perform an image adjustment operation which is performed by calling a service engineer in the related art. For this reason, it is possible to reduce the time required for the image adjustment, and it is possible to perform an efficient maintenance and management of the image forming apparatus 30.

In addition, in the example of the exemplary embodiment illustrated in FIG. 8A to (d) of FIG. 9, since the real adjustment factors are further displayed in a priority order, for example, even when the user with low ability performs the image adjustment, the image adjustment becomes easier, and thus it is difficult to fail the image adjustment.

In addition, in the exemplary embodiment, the management server 50 manages the information related to the image forming apparatus 30 or the information of the user in an integrated fashion. Accordingly, it is possible to store each history of the image adjustment of each of the image forming apparatuses 30 or the like, and it is possible to determine the acceptable adjustment factors or the adjustable amount by adding the history. In addition, the service engineer is able to refer to the history, and thus the history is useful information when the service engineer performs checking or the like with respect to the image forming apparatus 30. As a result, it is possible to perform a more efficient maintenance of the image forming apparatus 30.

Furthermore, in the example described above, the image forming apparatus 30 and the management server 50 are connected through the network 90 such as a LAN, but it is not limited thereto. In addition, the image forming apparatus 30 and the management server 50 may be connected on the Internet. Then, the function of the management server 50 may be provided as a cloud service.

In addition, in the example described above, the terminal apparatus 10 is connected to the image forming apparatus 30a, and the image adjustment of the image forming apparatus 30a is performed by using the terminal apparatus 10, but it is not limited thereto. For example, the terminal apparatus 10 may be directly connected to the network 90. Further, the image adjustment of the image forming apparatus 30a may be performed by embedding the function of the terminal apparatus 10 in the image forming apparatus 30a or the management server 50.

Description of Program

Furthermore, a process which is performed by the terminal apparatus 10 according to the exemplary embodiment is executed, for example, by loading various programs stored in the HDD 53 or the like to the main memory 52 by the CPU 51.

Accordingly, the process performed by the terminal apparatus 10 is able to be grasped as a program which causes a computer to realize a function of acquiring the acceptable adjustment factors which are factors for adjusting the image forming unit 301 and adjustment factors accepted to the user who performs the image adjustment, a function of acquiring the examination result of the image formed by the image forming unit 301, and a function of selecting the real adjustment factors which are factors for actually performing the image adjustment with respect to the image forming unit 301 among the acceptable adjustment factors based on the acquired examination result.

Furthermore, the program for realizing the exemplary embodiment is able to be provided by a communication unit, and is also able to be provided by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image adjusting apparatus, comprising:
an acceptable adjustment factor acquisition unit that acquires acceptable adjustment factors which are factors for adjusting an image forming unit and adjustment factors accepted to a user who performs an image adjustment;
an examination result acquisition unit that acquires an examination result of an image formed by the image forming unit; and
a real adjustment factor selection unit that selects real adjustment factors which are factors for actually performing an image adjustment with respect to the image forming unit among the acceptable adjustment factors based on the acquired examination result:
wherein the adjustment factors are accepted according to a difficulty level of the image adjustment for each instrument.

2. The image adjusting apparatus according to claim 1, wherein
the acceptable adjustment factor acquisition unit further acquires an adjustable amount which is able to be adjusted with respect to the acceptable adjustment factors.

3. The image adjusting apparatus according to claim 1, further comprising:
a recommendation value calculation unit that obtains a recommendation value of an adjustment with respect to the selected real adjustment factors.

4. The image adjusting apparatus according to claim 2, further comprising:
a recommendation value calculation unit that obtains a recommendation value of an adjustment with respect to the selected real adjustment factors.

5. The image adjusting apparatus according to claim 1, further comprising:
a priority order determination unit that determines a priority order required for the image adjustment of the image forming unit among the selected real adjustment factors.

6. The image adjusting apparatus according to claim 2, further comprising:
a priority order determination unit that determines a priority order required for the image adjustment of the image forming unit among the selected real adjustment factors.

7. The image adjusting apparatus according to claim 3, further comprising:
a priority order determination unit that determines a priority order required for the image adjustment of the image forming unit among the selected real adjustment factors.

8. The image adjusting apparatus according to claim 4, further comprising:
a priority order determination unit that determines a priority order required for the image adjustment of the image forming unit among the selected real adjustment factors.

9. An image forming apparatus, comprising:
an image forming unit that forms an image on a recording material; and
a display unit that displays real adjustment factors which are factors selected among acceptable adjustment factors which are factors for adjusting the image forming unit and adjustment factors accepted to a user who performs an image adjustment based on an examination result of an image formed by the image forming unit, and factors for actually performing an image adjustment with respect to the image forming unit by discriminating the real adjustment factors from the other factors;
wherein the adjustment factors are accepted according to a difficulty level of the image adjustment for each instrument.

10. A managing apparatus, comprising:
a management information storage unit that stores information of factors for adjusting an image forming unit and information of a user who performs an image adjustment; and
an acceptable adjustment factor determination unit that determines acceptable adjustment factors which are adjustment factors accepted to the user among the factors for adjusting the image forming unit based on the information of the user;
wherein the adjustment factors are accepted according to a difficulty level of the image adjustment for each instrument.

11. The managing apparatus according to claim 10, further comprising:
an adjustable amount determination unit that determines an adjustable amount which is able to be adjusted with respect to the acceptable adjustment factors based on the information of the user.
